(19) United States
(12) Patent Application Publication
(10) Pub. No.: US 2017/0234136 A1
(43) Pub. Date: Aug. 17, 2017

(54) TURBINE BLADE AND TURBINE

(71) Applicant: Siemens Aktiengesellschaft, Munich (DE)

(72) Inventors: Fathi Ahmad, Kaarst (DE); Nihal Kurt, Düsseldorf (DE); Radan Radulovic, Bochum (DE)

(73) Assignee: Siemens Aktiengesellschaft, Munich (DE)

(21) Appl. No.: 15/504,361

(22) PCT Filed: Aug. 27, 2015
(86) PCT No.: PCT/EP2015/069615

§ 371 Date: Feb. 16, 2017

(30) Foreign Application Priority Data
Aug. 27, 2014 (EP) 14182462.3

(51) Int. Cl. F01D 5/18; F01D 5/14

(52) U.S. Cl. CPC F01D 5/18; F01D 5/147; F05D 2260/941; F05D 2220/32

(57) ABSTRACT

A turbine blade with an internally cooled turbine blade airfoil, in which a hollow space is divided by rib elements in at least one cooling channel carrying a coolant, wherein a recess of material, which is arranged next to at least one rib element on a turbine blade airfoil wall, is embodied such that tensions occurring within the turbine blade airfoil can be reduced in a region surrounding the at least one rib element.

### CROSS REFERENCE TO RELATED APPLICATIONS

This application is the US National Stage of International Application No. PCT/EP2015/069615 filed Aug. 27, 2015, and claims the benefit thereof. The International Application claims the benefit of European Application No. EP14182462 filed Aug. 27, 2014. All of the applications are incorporated by reference herein in their entirety.

### FIELD OF INVENTION

The invention relates to a turbine blade having an internally cooled turbine blade airfoil, in which a cavity is divided by rib elements into at least one cooling duct conveying coolant and wherein the rib element in question extends longitudinally as far as a rib element end that has a free end in the cooling duct.

The invention further relates to a turbine, in particular a gas turbine, having at least one turbine stage comprising a multiplicity of turbine blades.

### BACKGROUND OF INVENTION

Generic turbine blades, turbines and gas turbines are already well known from the prior art.

Often, a turbine blade for this purpose is equipped with an internally cooled turbine blade airfoil, in order to be able to thermally and mechanically withstand even high temperatures prevailing in the turbine, in particular in a hot gas turbine. Specifically in hot gas turbines, the turbine blades are often subjected to higher thermal and mechanical loads, it being almost irrelevant in this case whether the turbine blade is a stator vane or a rotor blade of the turbine. In order to permit improved cooling of the turbine blade, an internally cooled turbine blade airfoil of this type has a cavity through which a coolant can be conveyed. In this cavity there is often additionally arranged a rib element or a multiplicity of rib elements, in order to form, in the cavity, at least one cooling duct with an often sinuous cooling duct profile, as are known for example from US 2010/0329888 A1. Even in the case of non-sinuous cooling ducts, rib element of this type are known for example from EP 1 757 773 A1, or also from EP 2 497 903 A2. In particular if the front side surface of the turbine blade airfoil and the rear side surface of the turbine blade airfoil are less thermally balanced, in this regard both a front side wall and a corresponding rear side wall of the turbine blade airfoil can experience high thermomechanical loads in the region of a rib element stiffening the turbine blade airfoil. This can give rise to partially critical stress states in the turbine blade airfoil, as a consequence of which the turbine blade is exposed in some regions to particularly disadvantageous load states, which can over time hasten material fatigue in those locations. Of particular note in this context are also the transition regions between the rib element and the front or rear side wall of the turbine blade airfoil.

### SUMMARY OF INVENTION

The invention has an object of further developing generic turbine blades in order to overcome at least the above-mentioned drawbacks.

An object of the invention is achieved with a turbine blade having an internally cooled turbine blade airfoil, in which a cavity is divided by at least one rib element into at least one cooling duct conveying coolant, wherein the rib element in question extends longitudinally as far as a rib element end that has a free end in the cooling duct, wherein on an internal side of a turbine blade airfoil wall, a material recess arranged next to the rib element end of the rib element in question is configured such that stresses arising within the turbine blade airfoil can be reduced in a region surrounding the at least one rib element.

By virtue of the inventive reduction or saving of material in a region surrounding the rib element, it is possible to significantly reduce stresses, especially those of thermomechanical origin, in transition regions between the rib element and the outer walls, that is to say the front and/or rear side walls, of the turbine blade, in the front side or the rear side proper, but also in the rib element itself, as a consequence of which it is accordingly possible to significantly delay material fatigue in thus critical regions.

In particular, thermomechanical stresses due to temperature differences between the suction side and the pressure side of the turbine blade airfoil can be significantly reduced in critical regions of the turbine blade airfoil.

Of course, it is possible in the present case not only for a single material recess but also for multiple material recesses to be arranged in one of the blade airfoil outer walls, in the vicinity of the rib element, in order to better counteract material fatigue.

Advantageously, the present material recess is configured such that it enables an improved stress distribution within the rib element, in transition regions between the actual rib element and the front side wall of the turbine blade airfoil and/or the rear side wall of the turbine blade airfoil, but also in the actual outer walls of the turbine blade airfoil. It is thus possible to achieve a stress reduction of at least 10% or advantageously of greater than 20% or 25%, in particular in critical surrounding areas or regions around the rib element end.

The term “material fatigue” in the context of the invention encompasses, in particular, fatigue crack formation which is due specifically to thermomechanical fatigue of the blade airfoil material.

A particular example of this is low cycle fatigue (LCF), that is to say short-timescale or low load cycle fatigue, relating to a low number of load cycles. In the present case, the possible number of load cycles can be increased by a factor of more than two, and in particular more than three, compared to previous common load cycle numbers.

In any case, the number of load cycles that can be achieved can be substantially increased, and thus especially the risk of premature LCF can be significantly reduced, by providing a corresponding material recess in the region surrounding the rib element, in accordance with the invention. It has been shown that the material recess according to the invention can significantly increase an LCF life expectancy of a turbine blade in this regard.

An embodiment variant provides that the material recess is arranged in a region surrounding a rib element end that has a free end in the cooling duct. More and/or greater thermomechanical stresses can arise especially in a region surrounding a rib element end that has a free end in a turbine blade airfoil cavity, where they can cause more rapid material fatigue.

A particular embodiment variant provides that the material recess is arranged on a turbine blade airfoil wall, axially in front of a head side of a rib element end that has a free end in the cooling duct. In other words: the material recess is arranged next to the head side of the rib element end such that the material recess is arranged in an imaginary extension of the rib element along its longitudinal extent. Higher critical stress states can arise especially in a region axially in front of the rib element end, which also formulates an inner curve limit of the cooling duct, which stress states then promote premature material fatigue at that point.

If the material recess is positioned axially in front of the head side of the rib element end, thermomechanical stresses arising there in particular in the turbine blade airfoil can be more expediently reduced.

Of course, the material recess can be arranged at different distances from the rib element, in particular from the rib element end, especially taking into account different designs of various turbine blades. In order to be able to expediently route stresses within the turbine blade airfoil, with a view to avoiding rapid material fatigue, it is particularly advantageous if the material recess is arranged on a turbine blade airfoil wall, spaced apart from the rib element by less than 30 mm or less than 20 mm, advantageously less than 10 mm.

In this context, the material recess can extend as far as the rib element or even be worked into the rib element. In the latter version, the rib element can have at least part of the material recess. Preferably, however, the material recess is arranged at a distance of greater than 1 mm or greater than 5 mm from the rib element.

Advantageously, the material recess is configured as at least a partial reduction in the thickness of a turbine blade airfoil wall. The material recess is for example shell-shaped.

In that regard, it is advantageous if the present material recess is arranged for example as a concave dent in the turbine blade airfoil outer wall.

As already indicated above, the material recess can have a different construction. It is particularly advantageous if the material recess is configured as at least a concave hollow in a turbine blade airfoil wall. A concave hollow has little or no effect on the aerodynamics of the turbine blade airfoil.

It is furthermore advantageous if the material recess is configured on the internal side of a turbine blade airfoil wall. In particular, a concave material recess makes it possible to advantageously redirect thermomechanical stresses in the region surrounding the rib element, in particular within the turbine blade airfoil outer wall. Furthermore, a material recess provided on an inner side, oriented toward the cavity or the cooling duct, of the turbine blade airfoil outer wall is least apparent in terms of fluid dynamics.

With regard to the temperature distribution in the turbine blade airfoil, it is expedient if the material recess is arranged on the rear side wall of the turbine blade airfoil.

Of course, the present material recess can be created with various geometric base area shapes.

It is advantageous if the base area shape of the material recess is circular or oval. Depending on the profile of the rib element within the turbine blade airfoil, different base area shapes can be advantageous.

Thus, it can alternatively be advantageous if the base area shape of the material recess is straight and elongate or curved and elongate.

If it proves expedient with regard to a rib element profile and/or a rib cross section or the like, or a turbine blade airfoil platform, it is also possible for the material recess to have a base area shape that is a combination of these, or an entirely different base area shape.

For example, the material recess is characterized by a trough-shaped or shell-shaped indentation introduced to the inner side of the turbine blade airfoil outer wall.

Since regions of the turbine blade airfoil with an increased risk of material fatigue are present especially in a region surrounding the rib element end that has a free end in the cooling duct, it is advantageous if the present material recess is arranged in a reversal region of the coolant duct.

In this context, the reversal region of the coolant duct corresponds to a bend of the sinuous cooling duct profile of the coolant duct.

The object of the invention is also achieved with a turbine, in particular a gas turbine, having at least one turbine stage comprising a multiplicity of turbine blades, wherein the at least one turbine stage comprises a multiplicity of turbine rotor blades and/or turbine stator vanes as per a turbine blade according to one of the features described here.

A turbine whose turbine blades are less loaded or endangered by material fatigue can not only be operated in a more operationally reliable and low-maintenance manner, but it also has a longer service life overall, and is therefore more economical to operate.

Not only does the present material recess make it possible to extend the life expectancy of a turbine blade, but also existing casting tools for producing a turbine blade of this type require not small design changes in order to produce the turbine blade according to the invention.

Further features, effects and advantages of the present invention will be explained by means of the appended drawing and the following description which illustrate and describe, by way of example, a turbine blade airfoil having a material recess arranged in the region of a rib element end of a rib element located within a cooling duct.

### BRIEF DESCRIPTION OF THE DRAWINGS

In the drawing:

FIG. 1 shows, schematically, a partial view of a turbine blade airfoil, in longitudinal section, with a rib element bounding a cooling duct, a material recess being formed on the inner side of the turbine blade airfoil in front of the rib element end thereof; and

FIG. 2 shows, schematically, a cross section through the turbine blade shown in FIG. 1.

### DETAILED DESCRIPTION OF INVENTION

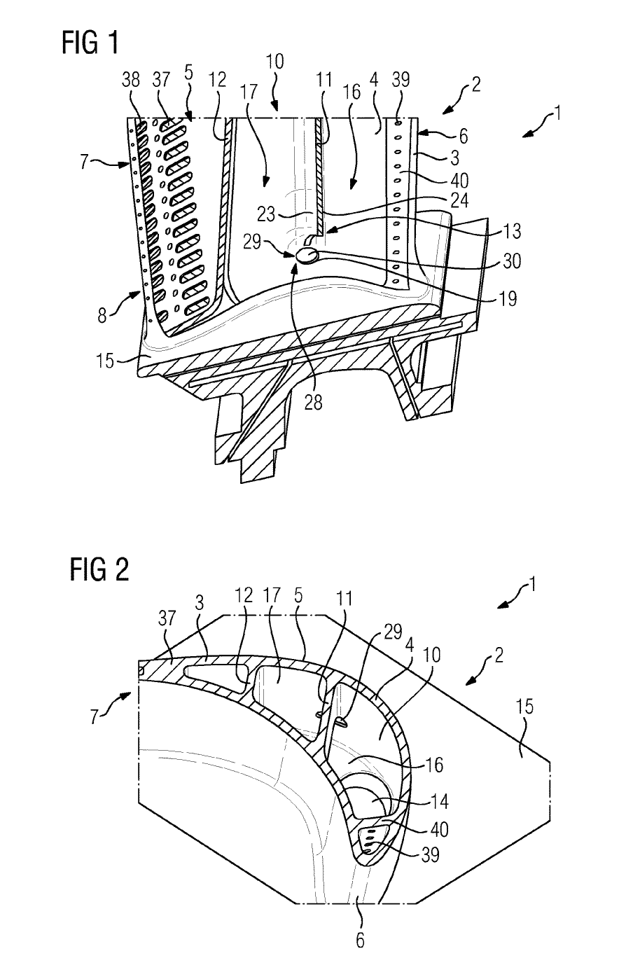

The turbine blade 1 in each case at least partially depicted in both FIGS. 1 and 2 is a rotor blade 2 of a hot gas turbine (not shown here).

The turbine blade 1 has an internally cooled turbine blade airfoil 3, the inner side 4 of the front side wall 5 of the turbine blade airfoil 3 being shown here (FIG. 1).

As shown in the illustration of FIG. 1, a leading edge region 6 of the turbine blade airfoil 3 is on the right-hand side. On the left-hand side is, accordingly, a trailing edge region 7 of the turbine blade airfoil 3, on which there is a multiplicity of cooling air exit bores 8 (numbered only by way of example). In particular in FIG. 2, the trailing edge region 7 is shown only partially.

In any case, the turbine blade airfoil 3 has a cavity 10, wherein in this case this cavity 10 is illustrated in FIG. 1 only partially by the inner side 4.

The cavity 10 contains in particular two rib elements 11 and 12 which form a highly convoluted cooling duct 13 with a sinuous cooling duct profile within the cavity 10. Along the convoluted cooling duct 13 or its sinuous cooling duct profile, cooling air as coolant can be conveyed through the turbine blade airfoil 3 in order to cool the latter from the inside.

In the case of the partially shown cooling duct 13, the cooling air coming from a root region, and thus from the direction of an opening 14 (shown only in FIG. 2) of a turbine blade root 15, flows essentially directly through a first cooling duct section 16 oriented toward the leading edge region 6, and a further cooling duct section 17 oriented toward the trailing edge region 7.

The sinuous cooling duct profile of the convoluted cooling duct 13 is, at least in the region of the partial view shown, configured in particular by the two rib elements 11 and 12, wherein the first rib element 11 spatially separates the two cooling duct sections 16 and 17 from one another.

In the present case, the first rib element 11 ends with its rib element end 24, defined by its head side 23, free in the cooling duct 13, specifically in the reversal region 19.

In particular in the region 28 surrounding the rib element end 24, there is the risk of critical thermomechanical stress states in particular in the transition regions between the first rib element 11 and the front side wall 5 of the turbine blade airfoil 3, and/or the rear side wall of the turbine blade airfoil 3, which can give rise to increased material fatigue there.

For that reason, a material recess 29 is formed on the inner side 4 in the region 28 surrounding the rib element end 24, in order to achieve an advantageous stress reduction in this region 28 surrounding the rib element end 24.

In this exemplary embodiment, the material recess 29 is arranged axially in front of the rib element end 24, at a distance of less than 10 mm from the head side 23.

Here, the material recess 29 is excavated as a concave, trough-shaped hollow 30 with an essentially oval base area (not explicitly numbered) on the inner side 4 of the front side wall 5 of the turbine blade airfoil 3.

In that respect, the material recess 29 also represents a partial reduction in the thickness of the front side wall 5 of the turbine blade airfoil 3.

Of course, a material recess 29 or partial reduction in wall thickness, which is identical or similar in this regard, can alternatively or additionally also be provided on the rear side wall (not shown here) of the turbine blade airfoil 3, at an identical, opposite location, or at an offset location.

Furthermore, other strengthening and guiding rib elements 37 (numbered only by way of example) and strengthening web elements 38 (numbered only by way of example) are also present and provide additional stabilization for the turbine blade airfoil 3 in the thinner trailing edge region 7.

Another strengthening rib 40, provided with bores 39, is provided in the leading edge region 6.

Although the invention has been described and illustrated in more detail by way of the preferred exemplary embodiment, the invention is not restricted by this disclosed exemplary embodiment and other variations can be derived herefrom by a person skilled in the art without departing from the scope of protection of the invention.

1.-12. (canceled)

13. A turbine blade comprising:
an internally cooled turbine blade airfoil, in which a cavity is divided by at least one rib element into at least one cooling duct conveying coolant, wherein the rib element in question extends longitudinally as far as a rib element end that has a free end in the cooling duct,
wherein a material recess arranged next to the rib element end of the rib element in question is configured such that stresses arising within the turbine blade airfoil are reducible in a region surrounding the at least one rib element,
wherein the material recess is arranged on an inner side of the turbine blade airfoil wall.

14. The turbine blade as claimed in claim 13,
wherein the material recess is arranged in a region surrounding the rib element end that has a free end in the cooling duct.

15. The turbine blade as claimed in claim 13,
wherein the rib element end comprises a head side and the material recess is arranged next to the head side such that the material recess is arranged in an imaginary extension of the rib element along its longitudinal extent.

16. The turbine blade as claimed in claim 13,
wherein the material recess is arranged on a turbine blade airfoil wall, spaced apart from the at least one rib element by less than 30 mm.

17. The turbine blade as claimed in claim 13,
wherein the material recess is configured as at least a partial reduction in the thickness of a turbine blade airfoil wall.

18. The turbine blade as claimed in claim 13,
wherein the material recess is configured as at least a concave hollow in a turbine blade airfoil wall.

19. The turbine blade as claimed in claim 13,
wherein the material recess is configured on the internal side of a turbine blade airfoil wall.

20. The turbine blade as claimed in claim 13,
wherein the material recess is arranged on the front side wall of the turbine blade airfoil.

21. The turbine blade as claimed in claim 13,
wherein the base area shape of the material recess is circular or oval.

22. The turbine blade as claimed in claim 13,
wherein the base area shape of the material recess is straight and elongate or curved and elongate.

23. The turbine blade as claimed in claim 13,
wherein the material recess is arranged in a reversal region of the cooling duct.

24. A turbine, comprising:
at least one turbine stage comprising a multiplicity of turbine blades,
wherein the at least one turbine stage comprises a multiplicity of turbine rotor blades and/or turbine stator vanes as per a turbine rotor blade as claimed in claim 13.

25. The turbine as claimed in claim 24,
wherein the turbine is a gas turbine.

26. The turbine blade as claimed in claim 13,
wherein the material recess is arranged on a turbine blade airfoil wall, spaced apart from the at least one rib element by less than 20 mm.

27. The turbine blade as claimed in claim 13,
wherein the material recess is arranged on a turbine blade airfoil wall, spaced apart from the at least one rib element by less than 10 mm.
